(19) United States
(12) Patent Application Publication
(10) Pub. No.: US 2020/0125802 A1
(43) Pub. Date: Apr. 23, 2020

(54) IDENTIFYING THEMES FROM CONTENT ITEMS OBTAINED BY A DIGITAL MAGAZINE SERVER TO USERS OF THE DIGITAL MAGAZINE SERVER

(71) Applicant: Flipboard, Inc., Redwood City, CA (US)

(72) Inventors: David E. Wigder, Bronx, NY (US); Ruth Zheng, New York, NY (US)

(21) Appl. No.: 16/661,670

(22) Filed: Oct. 23, 2019

Related U.S. Application Data
(60) Provisional application No. 62/749,626, filed on Oct. 23, 2018.

(51) Int. Cl. G06F 40/30; G06F 40/211; G06F 40/247; G06F 40/279

(52) U.S. Cl. CPC G06F 40/30; G06F 40/279; G06F 40/247; G06F 40/211

(57) ABSTRACT

A digital magazine server receives content items from various sources or information identifying content items maintained by various sources. Based on characteristics of the content items, the digital magazine server identifies themes of various content items. A theme of a content item identifies a primary topic or primary meaning of the content item. In various embodiments, the digital magazine server determines the theme of a content item based on words within the content item, accounting for meanings of words in the content item, parts of speech of each word, combinations of words in the content item, and syntax of words in the content item.

### CROSS-REFERENCE TO RELATED APPLICATIONS

This application claims the benefit of U.S. Provisional Application No. 62/749,626, filed Oct. 23, 2018, which is incorporated by reference in its entirety.

### BACKGROUND

This invention relates generally to identifying themes of content items obtained by a digital magazine server and more specifically to identifying themes of content items from characteristics of the obtained content items.

An increasing amount of content is provided to users through digital distribution channels. For example, users provide content items to online systems for distribution to users of the online systems. Many users seek to optimize content items provided to an online system for a specific audience. Conventionally, a user tailors a content item to a specific audience by initially creating the content item and subsequently modifying users to whom the content item is targeted or modifying components of the content item, such as images in the content item, a headline of the content item, or a portion of the content item initially visible to users.

However, conventional methods of selecting or tailoring content items for different audiences of users can be time consuming. Additionally, iteratively targeting of a content item based on presentation of the content item to users may limit effectiveness of the content item in reaching a desired audience, as the content item may be initially presented to a less desirable group of users. Similarly, iteratively revising a content item based on presentation of the content items to users results in more limited interaction with or access of the content items by users to whom the content item is initially presented. Hence, conventional iterative modification of content item presentation consumes additional computing resources by a user modifying characteristics of the content item and modifying targeting of the content item; additionally, iterative modification of presentation of a content item also uses an increased amount of network resources by communicating the content item to users who are less likely to interact with the content item or who are less likely to interact with certain versions of the content item. Further, while conventional selection of content for a user is based on topics or subtopics corresponding to different content items, topics or subtopics may provide limited information as to why users select or view different content items.

### SUMMARY

A digital magazine server receives content items from various sources or information identifying content items maintained by various sources. Based on characteristics of the content items, the digital magazine server identifies themes of various content items. A theme of a content item identifies a primary topic or primary meaning of the content item. In various embodiments, the digital magazine server determines the theme of a content item based on words within the content item, accounting for meanings of words in the content item, combinations of words in the content item, and syntax of words in the content item. While topic modeling typically account for nouns in a content item, when determining a theme of the content item, the digital magazine server analyzes combinations of words, parts of speech and syntax of the words used in a sentence. For example, the digital magazine server determines a more relevant topic or theme of a content item based on a subject or an object within one or more sentences of the content item, based on a verb or one or more adverbs in a sentence of the content item (allowing the digital magazine server to account for the verb or adverbs changing a topic or a theme associated with a subject or an object of the sentence), or based on verbs, adverbs, adjectives, dependent clauses, or prepositions included in a sentence of the content item. In various embodiments, the digital magazine server also determines a theme associated with images, video, or audio included in a content item, and determines a theme of the content item from the determined meaning of images, video, or audio included in the content item, as well as the words in the content item.

The digital magazine server applies one or more machine learned models to different groups of content items obtained by the digital magazine server to identify themes across the different groups of content items. For example, the digital magazine server applies a machined learned model to content items included in a specific digital magazine to identify themes of content items in the specific digital magazine. In another example, the digital magazine server applies a machine learned model to content items accessed by users having one or more specific characteristics or applies the machine learned model to content items included in digital magazines accessed by the users having the one or more specific characteristics. The digital magazine server may identify the themes determined for different groups of content items to a user, allowing the user to subsequently account for the identified themes when subsequently providing other content items to the digital magazine server for later presentation to users.

### BRIEF DESCRIPTION OF THE DRAWINGS

FIG. 1 is a block diagram of a system environment in which a digital magazine server operates, in accordance with an embodiment of the invention.

FIG. 2 is a block diagram of an architecture of the digital magazine server, in accordance with an embodiment of the invention.

FIG. 3 is an example presentation of content items in a digital magazine using a page template, in accordance with an embodiment of the invention.

FIG. 4 is a flowchart of a method for identifying one or more themes of content items obtained by a digital magazine server from characteristics of the content items, in accordance with an embodiment of the invention.

FIG. 5 is a flowchart of a method for evaluating user interaction with different content items corresponding to one or more themes, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Overview

A digital magazine server retrieves content from one or more sources and generates a personalized, customizable digital magazine for a user based on the retrieved content. For example, based on selections made by the user and/or on behalf of the user, the digital server application generates a digital magazine with one or more sections including content items retrieved from a number of sources and personalized for the user. A digital magazine application executing on a computing device (such as a mobile communication device, tablet, computer, or any other suitable computing system) retrieves the generated digital magazine and presents it to the user. The generated digital magazine allows the user to more easily consume content that interests and inspires the user by presenting content items in an easily navigable interface via a computing device.

The digital magazine may be organized into a number of sections that each include content having a common characteristic (e.g., content obtained from a particular source). For example, a section of the digital magazine includes articles from an online news source (such as a website for a news organization), another section includes articles from a third-party-curated collection of content associated with a particular topic (e.g., a technology compilation), and an additional section includes content obtained from one or more accounts associated with the user and maintained by one or more social networking systems. For purposes of illustration, content included in a section is referred to herein as “content items” or “articles,” which may include textual articles, pictures, videos, products for sale, user-generated content (e.g., content posted on a social networking system), advertisements, and any other types of content capable of display within the context of a digital magazine.

### System Architecture

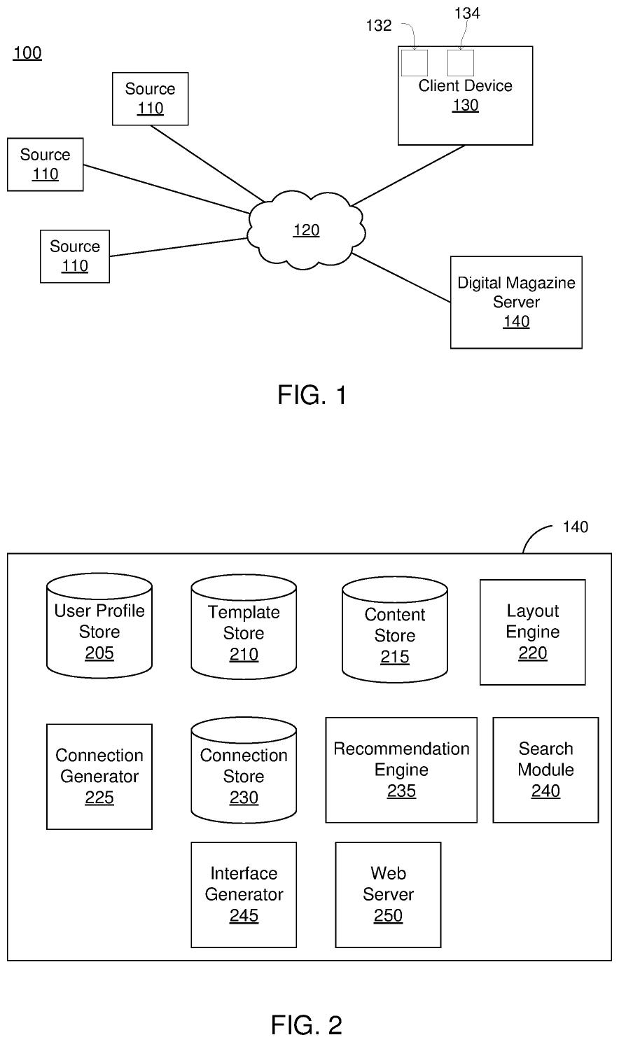

FIG. 1 is a block diagram of a system environment 100 for a digital magazine server 140. The system environment 100 shown by FIG. 1 comprises one or more sources 110, a network 120, a client device 130, and the digital magazine server 140. In alternative configurations, different and/or additional components may be included in the system environment 100. The embodiments described herein can be adapted to online systems that are not digital magazine servers 140.

A source 110 is a computing system capable of providing various types of content to a client device 130. Examples of content provided by a source 110 include text, images, video or audio on web pages, web feeds, social networking information, messages, and other suitable data. Additional examples of content include user-generated content such as blogs, tweets, shared images, video or audio, social networking posts, and social networking status updates. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as an “article,” a “content item,” or as “content.” An article or a content item may include various types of content, such as text, images, and video.

The sources 110 communicate with the client device 130 and the digital magazine server 140 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML), extensible markup language (XML), or JavaScript Object Notation (JSON). In some embodiments, all or some of the communication links of the network 120 may be encrypted using any suitable technique or techniques.

The client device 130 is one or more computing devices capable of receiving user input as well as transmitting and/or receiving data via the network 120. In one embodiment, the client device 130 is a conventional computer system, such as a desktop or laptop computer. Alternatively, the client device 130 may be a device having computer functionality, such as a personal digital assistant (PDA), a mobile telephone, a smartphone, or another suitable device. In one embodiment, the client device 130 executes an application allowing a user of the client device 130 to interact with the digital magazine server 140. For example, the client device 130 executes an application that communicates instructions or requests for content items to the digital magazine server 140 and presents the content to a user of the client device 130. As another example, the client device 130 executes a browser that receives pages from the digital magazine server 140 and presents the pages to a user of the client device 130. In another embodiment, the client device 130 interacts with the digital magazine server 140 through an application programming interface (API) running on a native operating system of the client device 130, such as IOS® or ANDROID™. While FIG. 1 shows a single client device 130, in various embodiments, any number of client devices 130 may communicate with the digital magazine server 140.

A display device 132 included in the client device 130 presents content items to a user of the client device 130. Examples of the display device 132 include a liquid crystal display (LCD), an organic light emitting diode (OLED) display, an active matrix liquid crystal display (AMLCD), or any other suitable device. Different client devices 130 may have display devices 132 with different characteristics. For example, different client devices 130 have display devices 132 with different display areas, different resolutions, or differences in other characteristics.

One or more input devices 134 included in the client device 130 receive input from the user. The client device 130 may include different input devices 134. In one embodiment, the client device 130 includes a touch-sensitive display for receiving input data, commands, or information from a user. In other embodiments, the client device 130 includes a keyboard, a trackpad, a mouse, or any other device capable of receiving input from a user. Additionally, in some embodiments, the client device may include multiple input devices 134. Inputs received via the input device 134 may be processed by a digital magazine application associated with the digital magazine server 140 and executing on the client device 130 to allow a client device user to interact with content items presented by the digital magazine server 140.

The digital magazine server 140 retrieves content items from one or more sources 110, generates pages in a digital magazine by processing the retrieved content, and provides the pages to the client device 130. As further described below in conjunction with FIG. 2, the digital magazine server 140 generates one or more pages for presentation to a user based on content items retrieved from one or more sources 110 and information describing organization and presentation of content items. For example, the digital magazine server 140 determines a page layout positioning content items relative to each other based on information associated with a user and generates a page including the content items positioned according to the determined layout for presentation to the user via the client device 130. This allows the user to access content items via the client device 130 in a format that enhances the user's interaction with and consumption of the content items. For example, the digital magazine server 140 provides a user with content items in a format similar to the format used by print magazines. By presenting content items in a format similar to that of a print magazine, the digital magazine server 140 allows a user to interact with content items from multiple sources 110 via the client device 130 more easily than when scrolling horizontally or vertically to access various content items.

FIG. 2 is a block diagram of an architecture of the digital magazine server 140. The digital magazine server 140 shown in FIG. 2 includes a user profile store 205, a template store 210, a content store 215, a layout engine 220, a connection generator 225, a connection store 230, a recommendation engine 235, a search module 240, an interface generator 245, and a web server 250. In other embodiments, the digital magazine server 140 may include additional, fewer, or different components for various applications. Conventional components such as network interfaces, security functions, load balancers, failover servers, management and network operations consoles, and the like are not shown so as to not obscure the details of the system architecture.

Each user of the digital magazine server 140 is associated with a user profile, which is stored in the user profile store 205. A user profile includes declarative information about the user that was explicitly shared by the user and may also include profile information inferred by the digital magazine server 140. In one embodiment, a user profile includes multiple data fields, each describing one or more attributes of the corresponding digital magazine server user. Examples of information stored in a user profile include biographic, demographic, and other types of descriptive information, such as hobbies or preferences, location, or other suitable information. A user profile in the user profile store 205 also includes data describing interactions by a corresponding user with content items presented by the digital magazine server 140. For example, a user profile includes a content item identifier, a description of an interaction with the content item corresponding to the content item identifier, and a time when the interaction occurred.

While user profiles in the user profile store 205 are frequently associated with individuals, user profiles may also be associated with entities such as businesses or organizations. This allows an entity to provide or access content items via the digital magazine server 140. An entity may post information about itself or its products, or provide other content items associated with the entity to users of the digital magazine server 140. For example, users of the digital magazine server 140 may receive a digital magazine or section including content items provided by an entity via the digital magazine server 140.

The template store 210 includes page templates each describing a spatial arrangement (“layout”) of content items relative to each other on a page for presentation to a user by a client device 130. A page template includes one or more slots, each configured to present one or more content items. In some embodiments, slots in a page template may be configured to present a particular type of content item or a content item having one or more specified characteristics. For example, a slot in a page template is configured to present an image while another slot in the page template is configured to present text. Each slot has a size (e.g., small, medium, or large) and an aspect ratio. One or more page templates may be associated with types of client devices 130, allowing content items to be presented in different locations and at different sizes when the content items are viewed on different client devices 130. Additionally, page templates may be associated with sources 110, allowing a source 110 to specify the format of pages presenting content items retrieved from the source 110. For example, a page template associated with an online retailer allows the online retailer to present content items via the digital magazine server 140 with a specific organization. Examples of page templates are further described in U.S. patent application Ser. No. 13/187,840, filed on Jul. 21, 2011, and U.S. patent application Ser. No. 13/938,227, filed on Jul. 9, 2013, each of which is hereby incorporated by reference in its entirety.

The content store 215 stores objects that each represent various types of content. For example, the content store 215 stores content items received from one or more sources 110 within a threshold time interval. Examples of content items stored by the content store 215 include a page post, a status update, an image, a photograph, a video, a link, an article, video data, audio data, a check-in event at a location, or any other type of content. A user may specify a section including content items having a common characteristic, in which case the common characteristic is stored in the content store 215 along with an association with the user profile or the user specifying the section.

The layout engine 220 retrieves content items from one or more sources 110 or from the content store 215 and generates a layout including the content items based on a page template from the template store 210. Based on the retrieved content items, the layout engine 220 may identify candidate page templates from the template store 210 and score the candidate page templates based on characteristics of the slots in different candidate page templates and based on characteristics of the content items. Based on the scores associated with candidate page templates, the layout engine 220 selects a page template and associates the retrieved content items with one or more slots to generate a layout where the retrieved content items are positioned relative to each other and sized based on their associated slots. When associating a content item with a slot, the layout engine 220 may associate the content item with a slot configured to present a specific type of content item or content items having one or more specified characteristics. Examples of using a page template to present content items are further described in U.S. patent application Ser. No. 13/187,840, filed on Jul. 21, 2011, U.S. patent application Ser. No. 13/938,223, filed on Jul. 9, 2013, and U.S. patent application Ser. No. 13/938,226, filed on Jul. 9, 2013, each of which is hereby incorporated by reference in its entirety.

The connection generator 225 monitors interactions between users and content items presented by the digital magazine server 140. Based on the interactions, the connection generator 225 determines connections between various content items, connections between users and content items, or connections between users of the digital magazine server 140. For example, the connection generator 225 identifies when users of the digital magazine server 140 provide feedback about a content item, access a content item, share a content item with other users, or perform other actions with content items. In some embodiments, the connection generator 225 retrieves data describing a user's interactions with content items from the user's user profile in the user profile store 205. Alternatively, user interactions with content items are communicated to the connection generator 225 when the interactions are received by the digital magazine server 140. The connection generator 225 may account for temporal information associated with user interactions with content items. For example, the connection generator 225 identifies user interactions with a content item within a specified time interval or applies a decay factor to identified user interactions based on times associated with the interactions. The connection generator 225 generates a connection between a user and a content item if the user's interactions with the content item satisfy one or more criteria. In one embodiment, the connection generator 225 determines one or more weights specifying a strength of the connection between the user and the content item based on the user's interactions with the content item that satisfy one or more criteria. Generation of connections between a user and a content item is further described in U.S. patent application Ser. No. 13/905,016, filed on May 29, 2013, which is hereby incorporated by reference in its entirety.

If multiple content items are connected to a user, the connection generator 225 establishes implicit connections between each of the content items connected to the user. In one embodiment, the connection generator 225 maintains a user content graph identifying the implicit connections between content items connected to the user. In one embodiment, weights associated with connections between a user and content items are used to determine weights associated with various implicit connections between the content items. User content graphs for multiple users of the digital magazine server 140 are combined to generate a global content graph identifying connections between various content items provided by the digital magazine server 140 based on user interactions with various content items. For example, the global content graph is generated by combining user content graphs based on mutual connections between various content items in user content graphs.

In one embodiment, the connection generator 225 generates an adjacency matrix from the global content graph or multiple user content graphs and stores the adjacency matrix in the connection store 230. The adjacency matrix describes connections between content items. For example, the adjacency matrix includes identifiers of content items and weights representing the strength or closeness of connections between content items. As an example, the weights indicate a degree of similarity in subject matter or other characteristics associated with various content items. In other embodiments, the connection store 230 includes various adjacency matrices determined from various user content graphs; the adjacency matrices may be analyzed to generate an overall adjacency matrix for content items retrieved by the digital magazine server 140. Graph analysis techniques may be applied to the adjacency matrix to rank content items, to recommend content items to a user, or to otherwise analyze relationships between content items. An example of the adjacency matrix is further described in U.S. patent application Ser. No. 13/905,016, filed on May 29, 2013, which is hereby incorporated by reference in its entirety.

In addition to identifying connections between content items, the connection generator 225 may also determine a social proximity between users of the digital magazine server 140 based on interactions between users and content items. The digital magazine server 140 determines social proximity, or “social distance,” between users using a variety of techniques. For example, the digital magazine server 140 analyzes additional users connected to each of two users of the digital magazine server 140 within a social networking system to determine the social proximity of the two users. In another example, the digital magazine server 140 determines social proximity between a user and an additional user by analyzing the user's interactions with content items posted by the additional user, whether presented using the digital magazine server 140 or another social networking system. Additional examples for determining social proximity between users of the digital magazine server 140 are described in U.S. patent application Ser. No. 13/905,016, filed on May 29, 2013, which is incorporated by reference in its entirety. In one embodiment, the connection generator 225 determines a connection confidence value between a user and an additional user of the digital magazine server 140 based on the user's and the additional user's common interactions with particular content items. The connection confidence value may be a numerical score representing a measure of closeness between the user and the additional user. For example, a larger connection confidence value indicates a greater similarity between the user and the additional user. In one embodiment, if a user has at least a threshold connection confidence value with another user, the digital magazine server 140 stores a connection between the user and the additional user in the connection store 230.

Using data from the connection store 230, the recommendation engine 235 identifies content items from one or more sources 110 for recommending to a digital magazine server user. Hence, the recommendation engine 235 identifies content items potentially relevant to a user. In one embodiment, the recommendation engine 235 retrieves data describing interactions between a user and content items from the user's user profile, connections between content items, and/or connections between users from the connection store 230. In one embodiment, the recommendation engine 235 uses stored information describing content items (e.g., topic, sections, subsections) and interactions between users and various content items (e.g., views, shares, saved, links, topics read, or recent activities) to identify content items that may be of interest to a digital magazine server user. For example, content items having an implicit connection of at least a threshold weight to a content item with which the user interacted are recommended to the user. As another example, the recommendation engine 235 presents a user with content items having one or more attributes in common with a content item with which an additional user having a threshold connection confidence score with the user interacted. Recommendations for additional content items may be presented to a user when the user views a content item using the digital magazine, as a notification to the user by the digital magazine server 140, or to the user through any suitable communication channel.

In one embodiment, the recommendation engine 235 applies various filters to content items received from one or more sources 110 or from the content store 215 to efficiently provide a user with recommended content items. For example, the recommendation engine 235 analyzes attributes of content items in view of characteristics of a user from the user's user profile. Examples of attributes of content items include a type (e.g., image, story, link, video, audio, etc.), a source 110 from which a content item was retrieved, time when a content item was retrieved, and subject matter of a content item. Examples of characteristics of a user include biographic information about the user, users connected to the user, and interactions between the user and content items. In one embodiment, the recommendation engine 235 analyzes attributes of content items in view of a user's characteristics for a specified time period to generate a set of recommended content items. The set of recommended content items may be presented to the user or further analyzed based on user characteristics and on content item attributes to generate a more refined set of recommended content items. A setting included in a user's user profile may specify a length of time that content items are analyzed before identifying recommended content items to the user, allowing a user to balance refinement of recommended content items with time used to identify recommended content items.

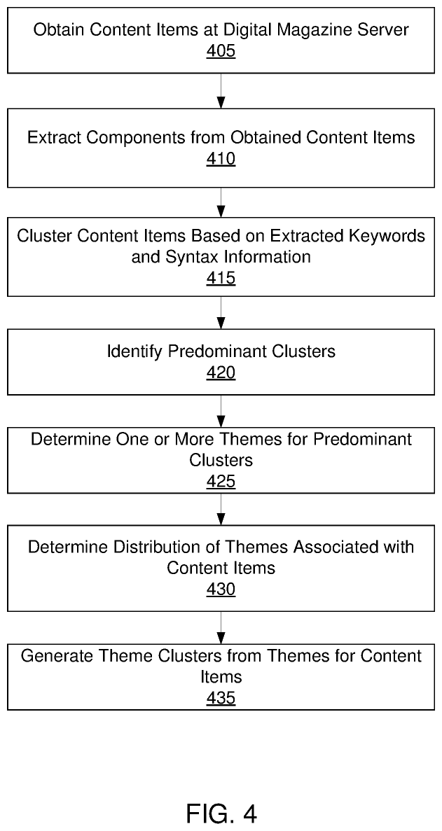

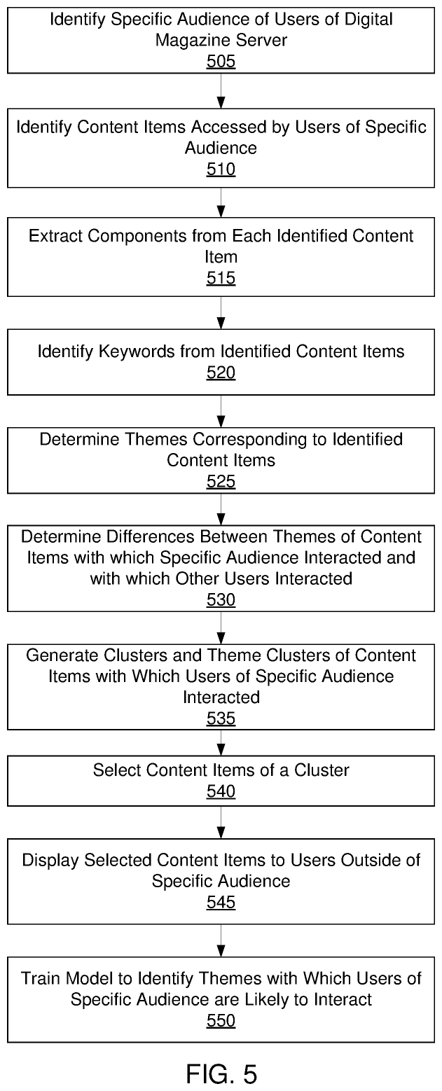

As further described below in conjunction with FIGS. 4 and 5, in various embodiments the recommendation engine 235 extracts topics from content items and identifies themes for various content items. A theme of a content item identifies a primary topic or primary meaning of the content item. In various embodiments, the digital magazine server determines the theme of a content item based on words within the content item, accounting for meanings of words in the content item, combinations of words in the content item, and syntax of words in the content item. As further described below in conjunction with FIG. 4, the recommendation engine 235 analyzes parts of speech and other syntax information from sentences in a content item. For example, the recommendation engines 235 server determines a more relevant topic or theme of a content item based on a subject or an object within one or more sentences of the content item, based on a verb or one or more adverbs in a sentence of the content item (allowing the digital magazine server to account for the verb or adverbs changing a topic or a theme associated with a subject or an object of the sentence), or based on verbs, adverbs, adjectives, dependent clauses, or prepositions included in a sentence of the content item. In various embodiments, the recommendation engine 235 also determines a meaning of images, video, or audio included in a content item, and determines a theme of the content item from the determined meaning of images, video, or audio included in the content item, as well as the words in the content item. Additionally, as further described below in conjunction with FIG. 5, the recommendation engine 235 trains one or more models from themes (or topics, or keywords) for various content items and characteristics of users who interacted with presented content items to determine likelihoods of a user performing one or more interactions with content items based on one or more themes for the content items and characteristics of a user to whom the content items are presented. The one or more models allow the recommendation engine 235 to identify themes, keywords, or topics for content items to a publishing user, allowing the publishing user to generate content items for the digital magazine server 140 that have a theme, a topic, or a keyword likely to cause one or more interactions by users with the content items.

hat is based on prior interactions with content items as well as topics associated with content items. For example, the recommendation engine 235 obtains a topic model that determines topics or concepts associated with content items based on words or phrases included in content items. In various embodiments, a theme is associated with one or more topics, allowing the recommendation engine 235 to maintain a hierarchy of themes or topics as well as to determine relationships between themes and topics. As described above, the recommendation engine 235 uses similarities between topics or themes associated with content items presented to a user, or associated with content items with which the user interacted, to recommend other content items to the user. Hence, the topic model uses characteristics of content items and characteristics of digital magazines including the content items to associate topics with content items.

The search module 240 receives a search query from a user and retrieves content items from one or more sources 110 based on the search query. For example, content items having at least a portion of an attribute matching at least a portion of the search query are retrieved from one or more sources 110. The user may specify sources 110 from which content items are retrieved through settings maintained by the user's user profile or by specifying one or more sources in the search query. In one embodiment, the search module 240 generates a section of the digital magazine including the content items identified based on the search query, as the identified content items have a common attribute of their association with the search query. Presenting identified content items from a search query in a section of the digital magazine allows a user to more easily identify additional content items at least partially matching the search query when additional content items are provided by sources 110.

To more efficiently identify content items based on search queries, the search module 240 may index content items, groups (or sections) of content items, and user profile information. In one embodiment, the index includes information about various content items, such as author, source, topic, creation data/time, user interaction information, document title, or other information capable of uniquely identifying the content item. Search queries are compared to information maintained in the index to identify content items for presentation to a user. The search module 240 may present identified content items based on a ranking. One or more factors associated with the content items may be used to generate the ranking. Examples of factors include global popularity of a content item among users of the digital magazine server 140, connections between users interacting with a content item and the user providing the search query, and information from a source 110. Additionally, the search module 240 may assign a weight to the index information associated with each content item based on similarity between index information and a search query and rank the content items based on their weights. For example, content items identified based on a search query are presented in a section of the digital magazine in an order based in part on the ranking of the content items.

To increase user interaction with the digital magazine, the interface generator 245 maintains instructions associating received input with actions performed by the digital magazine server 140 or by a digital magazine application executing on a client device 130. For example, instructions maintained by the interface generator 245 associate types of inputs or specific inputs received via an input device 132 of a client device 130 with modifications to content presented by a digital magazine. As an example, if the input device 132 is a touch-sensitive display, the interface generator 245 maintains instructions associating different gestures with navigation through content items or presented via a digital magazine. Instructions maintained by the interface generator 245 are communicated to a digital magazine application or other application executing on a client device 130 on which content from the digital magazine server 140 is presented. In various embodiments, the interface generator 245 communicates instructions to a client device 130 identifying topics or themes associated with a content item and probabilities of the topics or themes being associated with the content item; the generated interface also includes options for a user to whom the interface is presented to increase or decrease the probability of a topic or a theme being associated with the content item by interacting with an option included in the interface, as further described below in conjunction with FIG. 5.

The web server 250 links the digital magazine server 140 via the network 120 to the one or more client devices 130, as well as to the one or more sources 110. The web server 250 serves web pages, as well as other content, such as JAVA®, FLASH®, XML, and so forth. The web server 250 may retrieve content items from one or more sources 110. Additionally, the web server 250 communicates instructions for generating pages of content items from the layout engine 220 and instructions for processing received input from the interface generator 245 to a client device 130. The web server 250 also receives requests for content or other information from a client device 130 and communicates the request or information to components of the digital magazine server 140 to perform corresponding actions. Additionally, the web server 250 may provide application programming interface (API) functionality to send data directly to native client device operating systems, such as IOS®, ANDROID™, WEBOS®, or BlackberryOS.

For purposes of illustration, FIG. 2 describes various functionalities provided by the digital magazine server 140. However, in other embodiments, the above-described functionality may be provided by a digital magazine application executing on a client device 130 or by a combination of the digital magazine server 140 and a digital magazine application executing on a client device 130.

### Page Templates

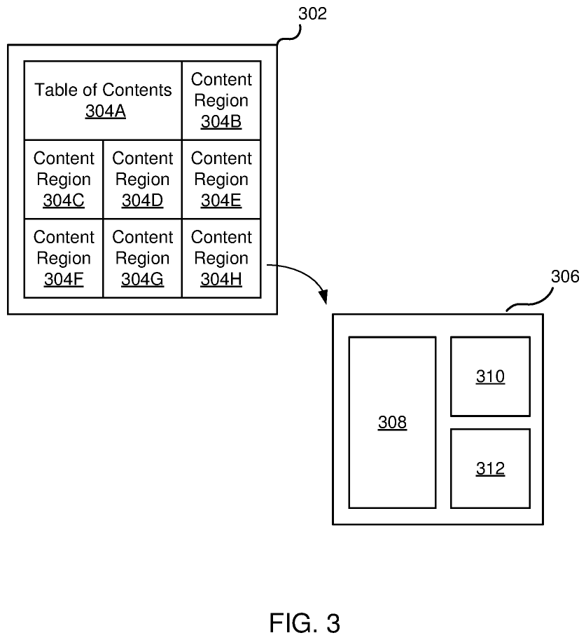

FIG. 3 illustrates an example page template 302 having multiple rectangular slots each configured to present a content item. Other page templates with different configurations of slots may be used by the digital magazine server 140 to present one or more content items received from sources 110. As described above in conjunction with FIG. 2, in some embodiments, one or more slots in a page template are reserved for presentation of a specific type of content item or content items having specific characteristics. In one embodiment, the size of a slot may be specified as a fixed aspect ratio or using fixed dimensions. Alternatively, the size of a slot may be flexible, where the aspect ratio or one or more dimensions of a slot is specified as a range, such as a percentage of a reference or a base dimension. Arrangement of slots within a page template may also be hierarchical. For example, a page template is organized hierarchically, where an arrangement of slots may be specified for the entire page template or for one or more portions of the page template.

In the example of FIG. 3, when a digital magazine server 140 generates a page for presentation to a user of a client device 130, the digital magazine server 140 populates slots in a page template 302 with content items. Information identifying the page template 302 and associations between content items and slots in the page template 302 is stored and used to generate the page. For example, to present a page to a user, the layout engine 220 identifies the page template 302 from the template store 210 and retrieves content items from one or more sources 110 or from the content store 215. The layout engine 220 generates data or instructions associating content items with slots within the page template 302. Hence, the generated page includes various “content regions” presenting one or more content items associated with a slot in a location specified by the slot.

A content region 304 may present image data, text data, a combination of image and text data, or any other information retrieved from a corresponding content item. For example, in FIG. 3, the content region 304A represents a table of contents identifying sections of a digital magazine, and content associated with the various sections are presented in content regions 304B-304H. For example, content region 304A includes text or other data indicating that the presented data is a table of contents, such as the text “Cover Stories Featuring,” followed by one or more identifiers associated with various sections of the digital magazine. In one embodiment, an identifier associated with a section describes a characteristic common to at least a threshold number of content items in the section. For example, an identifier refers to the name of a user of social network from which content items included in the section are retrieved. As another example, an identifier associated with a section specifies a topic, an author, a publisher (e.g., a newspaper, a magazine) or other characteristic associated with at least a threshold number of content items in the section. Additionally, an identifier associated with a section may further specify content items selected by a user of the digital magazine server 140 and organized as a section. Content items included in a section may be related topically and include text and/or images related to the topic.

Sections may be further organized into subsections, with content items associated with one or more subsections presented in content regions 304. Information describing sections or subsections, such as a characteristic common to content items in a section or subsection, may be stored in the content store 215 and associated with a user profile to simplify generation of a section or subsection for the user. A page template 302 associated with a subsection may be identified, and slots in the page template 302 associated with the subsection may be used to determine the presentation of content items from the subsection relative to each other. Referring to FIG. 3, the content region 304H includes a content item associated with a newspaper to indicate a section including content items retrieved from the newspaper. When a user interacts with the content region 304, a page template 302 associated with the section is retrieved, as well as content items associated with the section. Based on the page template 302 associated with the section and the content items, the digital magazine server 140 generates a page presenting the content items based on the layout described by the slots of the page template 302. For example, in FIG. 3, the section page 306 includes content regions 308, 310, 312 presenting content items associated with the section. The content regions 308, 310, 312 may include content items associated with various subsections including content items having one or more common characteristics (e.g., topics, authors, etc.). Hence, a subsection may include one or more subsections, allowing hierarchical organization and presentation of content items by a digital magazine.

Identifying One or More Themes of Content Items from Characteristics of the Content Items

FIG. 4 is a flowchart of one embodiment of a method for identifying one or more themes of content items obtained by a digital magazine server from characteristics of the content items. In various embodiments, the method may include different or additional steps than those described in conjunction with FIG. 4. Additionally, in some embodiments, the method may perform the steps in different orders than the order described in conjunction with FIG. 4.

A digital magazine server 140 obtains 405 content items from one or more sources 110. In some embodiments, the obtained content items are included in one or more digital magazines maintained by the digital magazine server 140. For example, the digital magazine server 140 obtains 405 a content item from a source 110 in conjunction with an identifier of a digital magazine in which the content item is included. In various embodiments, the digital magazine server 140 stores an identifier of a digital magazine in association with identifiers of content items obtained 405 by the digital magazine server 140 that are included in the digital magazine, along with characteristics of the digital magazine, such as a title and a description of the digital magazine. The title and the description of the digital magazine are received from a user or a source 110 who provided the digital magazine server 140 with information identifying the digital magazine. Alternatively, the digital magazine server 140 obtains 405 content items previously received from one or more sources 110, such as content items included in one or more digital magazines the digital magazine server 140 previously presented to one or more users.

The digital magazine server 140 extracts 410 components from each of the obtained content items. In some embodiments, the digital magazine server 140 identifies a set of components of a content item that are presented to a user to identify the content item. For example, the digital magazine server 140 identifies a title, one or more headlines, an abstract, one or more images, or other information that is displayed to a user to identify the content item to the user before the user selects the content item for viewing. Additionally, the digital magazine server 140 extracts 410 keywords from text within the content item. In some embodiments, the digital magazine server 140 also applies one or more trained models to categorize image data, video data, the audio data included in a content item from features or characteristics of the image data, the video data, or the audio data, allowing the digital magazine server to account for content of image, video, or audio data in a keyword when extracting 410 keywords from a content item.

Further, when extracting 410 components from a content item, the digital magazine server 140 identifies sentence structure of text in the content item. For example, the digital magazine server 140 identifies different sentences from text in the content item and identifies independent and dependent clauses within different sentences. In various embodiments, the digital magazine server 140 uses different parts of speech, such as prepositions or adverbs, identified by a trained model to identify independent clauses or dependent clauses within a sentence, allowing the digital magazine server 140 to distinguish between a main idea of a sentence, identified from the independent clauses, and supporting ideas of the sentence, identified from the dependent clauses. Additionally, the online system 140 identifies keywords from each sentence of the content item, as well as a part of speech (e.g., noun, verb, adjective, adverb) of each keyword using one or more models. The digital magazine server 140 further analyzes text in a content item to identify words that change the meaning of other words in a sentence (e.g., “not” preceding another word), and identifies groups of related words in a sentence based on combinations of nouns and verbs or based on a structure or an order of the words in a sentence. Additionally, the digital magazine server 140 assigns a relationship score to each word in a sentence based on how closely a word is related to a subject of the sentence or an amount the word contributes to defining an intention of the subject of the sentence.

For example, a content item includes a headline of “The bank rejected the credit card application.” While the subject of the sentence in the preceding example is “bank,” the phrase “credit card application” is more relevant to most users of the digital magazine server 140. Hence, by extracting 410 “bank” and “credit card application” from the headline, and identifying syntax information for “bank” as a subject and for “credit card application” as object, the digital magazine server 140 identifies “credit card application” as a keyword or phrase for the content item. As another example, for a sentence in a content item of “The bank launched the credit card,” the digital magazine server 140 extracts 410 the verb “launched” from the sentence, while extracting 410 “bank” and its syntax information as a subject and “credit card,” as well as its syntax information as an object. Extracting 410 parts of speech and syntax information for different words in the preceding example allows the digital magazine server 140 to account for relationships between the verb and the object of the sentence to subsequently identify a theme of the content item as relating to poor credit or other themes encompassing topics relating to rejection of credit card applications. Additionally, extracting parts of speech as well as words or phrases allows the digital magazine server 140 to use words identified as verbs to provide context for other words identified as a subject or as an object of a sentence in a content item. For example, accounting for a verb, such as “launch,” allows the digital magazine server 140 to identify an object of a sentence, rather than a subject of the sentence, as a keyword more reflective of the sentence.

In other examples, extracting 410 syntax information identifying parts of speech of sentences in content items allow the digital magazine server 140 to account for modification of a subject or an object of a sentence from a content item by adverbs or by other words. For example, in a sentence extracted 410 from a content item of “The bank mistakenly rejected the application,” extracting 410 syntax information identifying “bank” as a subject, “mistakenly” as an adverb, “rejected” as a verb, and “application” as an object, allows the digital magazine server 140 to account for the negative connotation of “mistakenly” regarding the verb “rejected” to identify “bank” as a keyword for the content item and “bank error” as another keyword by accounting for both “mistaken” and “bank,” subsequently causing the digital magazine server 140 to identify a theme including topics or keywords associated with bank errors. As another example, syntax information extracted 410 from a sentence in a content item identifies a dependent clause or prepositions in the sentence, which the digital magazine server 140 uses as contextual information to identify a subject or an object of the sentence as a keyword or a topic of the sentence. For example, in the sentence “When I was buying a car, the bank rejected the application,” the digital magazine server 140 extracts 410 characteristics identifying the dependent clause “When I was buying a car” and the corresponding parts of speech for each word to identify a keyword corresponding to the subject or the object of the sentence, so the digital magazine server 140 identifies a keyword or a topic of a car loan or car financing for the content item from the sentence.

The digital magazine server 140 also maintains a taxonomy defining relationships between various words, such as synonyms or antonyms for words, or words having a common meaning, and identifies synonyms for different words and words or phrases similar or related to other words or phrases. From the maintained taxonomy, the digital magazine server 140 identifies synonyms or related terms or phrases for each word identified from the content item. Similarly, the digital magazine server 140 identifies antonyms for words identified from the content item, as well as words or phrases similar to or related to the identified antonyms.

From words and syntax information extracted 410 from various content items, the digital magazine server 140 clusters 415 content items, where a cluster of content items each include one or more common words or common syntax information. In one embodiment, the digital magazine server 140 uses K-means clustering to cluster 415 content items based on vectors representing words or syntax information extracted 410 from different content items. Using K-means clustering causes a content item to be clustered based on the distance of each dimension of a vector representing the content item to a mean value associated with a dimension across all vectors. For example, content items having a value associated with a dimension that is within a specified distance to a mean value associated with the dimension are included in a cluster. When clustering 415 content items, the digital magazine server 140 uses the maintained taxonomy to equate words extracted 410 from a content item with closely related words, analogous words, or synonyms, allowing the content item to be included in a cluster with content items from which a synonym, closely related word, or analogous word was extracted 410; for example, the maintained taxonomy identifies “puppy” as closely related to “dog,” so the digital magazine server 140 clusters 415 content items from which “dog” was extracted 410 with content items from which “puppy” was extracted.

In some embodiments, the digital magazine server 140 clusters content items based on combinations of nouns and verbs, so the digital magazine server 140 identifies a noun and a verb from a content item and clusters 415 the content item with other content items from which the same noun and verb were identified. Alternatively, the digital magazine server clusters 415 content items by identifying a combination of multiple words from a content item, determining a part of speech for each word of the combination, and using the taxonomy maintained by the digital magazine server 140 to cluster 415 content items including the combination of multiple words or including a combination of words synonymous, or related to, the combination of words. However, in other embodiments, the digital magazine server 140 clusters 415 content items based on words and syntax information extracted 410 from the content items using any suitable method or combination of methods.

The digital magazine server 140 identifies 420 predominant clusters of content items. In some embodiments, the digital magazine server 140 identifies 420 predominant clusters as clusters in which the content items of the cluster have at least a threshold measure of similarity to each other. For example, the digital magazine server 140 determines an average measure of similarity of content items in a cluster to each other for each cluster, and ranks the clusters by their corresponding average measure of similarity. The digital magazine server 140 identifies 420 clusters having at least a threshold position in the ranking as predominant clusters or identifies 420 clusters with a corresponding average measure of similarity equaling or exceeding a threshold value as predominant clusters. In some embodiments, the digital magazine server 140 also accounts for numbers of content items included in different clusters when identifying 420 predominant clusters. For example, the digital magazine server 140 augments an average measure of similarity corresponding to a cluster by an amount that is proportional to a number of content items in the cluster, increasing a likelihood of clusters including larger numbers of content items as being identified 420 as predominant clusters. Alternatively, the digital magazine server 140 identifies 420 predominant clusters based on numbers of content items included in the clusters. For example, the digital magazine server 140 ranks clusters based on a number of content items included in different clusters and identifies 420 predominant clusters as clusters having at least a threshold position in the ranking. In another embodiment, the digital magazine server 140 identifies 420 predominant clusters as clusters including at least a threshold number of content items.

From the predominant clusters, the digital magazine server 140 determines 425 one or more themes for predominant clusters of content items. In various embodiments, the digital magazine server 140 determines 425 a theme for a predominant cluster based on words and parts of speech of the words extracted 410 from content items of the predominant cluster. For example, the digital magazine server 140 selects keywords for a cluster as words included in at least a threshold percentage of content items of the cluster, accounting for inclusion of synonyms for or related words to words in content items of the cluster. The digital magazine server 140 may select one or more keywords having different parts of speech when selecting the keyword; for example, the digital magazine server 140 identifies a specific number of keywords that are nouns, a specific number of keywords that are verbs, and a specific number of keywords having one or more other parts of speech. To determine 425 a theme for a predominant cluster, the digital magazine server 140 generates one or more sentences by combining keywords having different parts of speech. In various embodiments, the digital magazine server 140 uses one or more natural language processing methods to generate the one or more sentences from the keywords from a predominant cluster.

Additionally, the digital magazine server 140 also determines 430 a theme distribution of themes maintained by the digital magazine server 140 from keywords or themes from clusters of content items, where each theme includes one or more topics, or keywords corresponding to themes. For example, a theme of “pets” includes topics of “dogs” and “cats.” From the theme distribution, the digital magazine server 140 determines one or more higher-level themes associated with the content items; for example, the theme distribution allows the digital magazine server 140 to determine a theme of “dog” is associated with a content item including keywords of “puppies” and “dog food.” The digital magazine server 140 also determines a distribution of keywords maintained by the digital magazine server 140. The theme distribution is a Dirichlet distribution based on a theme prior and a number of themes maintained by the digital magazine server 140, while the distribution of keywords is also a Dirichlet distribution based on a keyword prior and a number of keywords maintained by the digital magazine server 140. The theme prior affects a distribution of words or phrases per theme, while the keyword prior affects a distribution of words or phrases per theme or keyword. In various embodiments, the theme prior and the keyword prior are parameters stored by the digital magazine server 140 or specified by an administrator of the digital magazine server 140. The administrator may specify a theme prior where each theme includes a limited number of labels and may also specify a keyword prior where each topic includes a limited number of terms from content items. The digital magazine server 140 concurrently determines the theme distribution and determine the topic distribution in various embodiments, or may determine the theme distribution and determine the topic distribution in any suitable order in various embodiments.

For each content item, the digital magazine server 140 determines 430 a distribution of themes associated with the content item based on labels associated with content items and the number of times the labels were associated with content item. In various embodiments, the distribution of themes associated with the content item is a categorical distribution based on a number of labels associated with the content item and numbers of times different labels were associated with the content item. Hence, the distribution of themes associated with the content item represents probabilities of different themes being associated with the content item based on the number of times different labels were associated with the content item.

From the distribution of themes associated with each content item, the digital magazine server 140 determines a parameter defining a relationship between the distribution of themes associated with a content item and a distribution of themes or keywords associated with the content item based on a number of labels associated with the content item. In some embodiments, the parameter is based on a number of labels associated with the content item. For example, the digital magazine server 140 determines the parameter based on a normalized vector of numbers of different labels associated with content items; the digital magazine server 140 applies one or more factors to the normalized vector of numbers of different labels associated with the content item when determining the parameter defining the relationship between the distribution of themes associated with the content item and a distribution of keywords associated with the predominant cluster.

From the theme distribution, the digital magazine server 140 determines 430 themes associated with different content items, and generates 435 theme clusters of content items based on the themes associated with different content items, as further described above. Hence, a theme cluster includes content items having a common theme, which describes the theme cluster at a more general level than the extracted words and parts of speech used to cluster 415 the content items. This allows the digital magazine server 140 to identify broader themes identified by content items in a theme cluster that account for probabilities of different words relating to a common theme being in content items included in a theme cluster corresponding to the common theme; for example, a theme cluster includes content items with keywords of “dog” and “cat,” because a theme of “pets” includes both “dog” and “cat.” Hence, generating 435 theme clusters allows the digital magazine server 140 to identify higher level themes from content items, providing users with more generalized information about content items included in digital magazines or otherwise presented to users by the digital magazine server 140.

In addition to identifying themes or themes from content items, based on interactions with content items presented by the digital magazine server 140, the digital magazine server 140 also determines user interactions with content items associated with different themes. FIG. 5 is a flowchart of one embodiment of a method for evaluating user interaction with different content items corresponding to one or more themes. In various embodiments, the method includes different or additional steps than those described in conjunction with FIG. 5. Additionally, in some embodiments, steps of the method are performed in different orders than the order described in conjunction with FIG. 5.

The digital magazine server 140 identifies 505 a specific audience of users so each user of the audience includes one or more common characteristics. A user of the digital magazine server may identify the one or more common characteristics of the digital magazine server 140, which identifies 505 users having at least a threshold amount of the common characteristics from information the online system 140 maintains for various users in various embodiments. However, the digital magazine server 140 may store one or more common characteristics identifying 505 a specific audience of users, and identifies 505 the audience of users by identifying users having the stored one or more characteristics defining the specific audience.

The digital magazine server 140 identifies 510 content items accessed by users of the identified audience. In one embodiment, the digital magazine server 140 retrieves stored information identifying one or more specific actions performed by users of the identified audience and identifies 510 content items corresponding to the identified one or more specific actions. For example, the digital magazine server 140 identifies 510 content items that one or more users of the identified audience selected or identifies 510 content items that one or more users of the identified audience accessed for at least a threshold amount of time.

The digital magazine server 140 extracts 515 components from each of the identified content items. As further described above in conjunction with FIG. 4, the digital magazine server 140 extracts 515 various words from text included in an identified content item. As further described above in conjunction with FIG. 4, the digital magazine server 140 extracts words, part of speech information, and syntax information from text included in an identified content item and identifies 520 keywords from the identified content item. Hence, the digital magazine server 140 identifies 520 keywords (which may be combinations of words or phrases) from each of the identified content items. The digital magazine server 140 also determines 525 one or more themes corresponding to each of the identified content items, as further described above in conjunction with FIG. 4.

Based on interactions by users of the digital magazine server 140 with content items presented by the digital magazine server, the digital magazine server 140 determines 530 differences between keywords or themes with which users of the specific audience interact and keywords or themes of content items with which other users interact. In some embodiments, the digital magazine server 140 determines 530 a difference between keywords or themes of content items with which overall users of the digital magazine server 140 interacted and keywords or themes of content items with which users of the specific audience interacted. Alternatively, the digital magazine server 140 determines 530 differences between keywords or themes of content items with which users of an alternative audience interacted and keywords or themes of content items with which users of the specific audience interacted. The alternative audience includes users having different common characteristics than users of the specific audience in the preceding example. In some embodiments, the digital magazine server 140 determines a distribution of themes (or keywords) of content items with which users of the specific audience interacted and determines an alternative distribution of themes (or keywords) of content items with which users of a different audience (e.g., overall users of the digital magazine server 140, users of an alternative audience) and determines 530 a difference between the distribution and the alternative distribution. For example, the digital magazine server 140 determines 530 a Kullback-Leibler divergence between the distribution of themes (or keywords) and the alternative distribution of themes (or keywords).

If the determined difference between keywords or themes with which users of the specific audience interact and keywords or themes of content items with which other users interact equals or exceeds a threshold value, the digital magazine server 140 generates 535 clusters of content items with which users of the specific audience interacted and theme clusters of the content items with which users of the specific audience interacted, as further described above in conjunction with FIG. 4. This allows the digital magazine 140 to identify content items with which the users of the specific audience interacted that correspond to different keywords or that correspond to different themes more or less than other users (e.g., users in a different audience, overall users of the digital magazine server 140).

In various embodiments, the digital magazine server 140 also evaluates performance of content items of one or more clusters with which users of the specific audience interacted against other users by selecting 540 content items of a cluster with which users of the specific audience interacted and displaying 545 content items of the cluster to other users outside of the specific audience, such as overall users of the digital magazine server 140 or users in an alternative audience having different common characteristics than the specific audience. For example, the digital magazine server 140 includes selected content items of the cluster in digital magazines generated for users not in the specific audience or recommends selected content items of the cluster to users not in the specific audience.

Based on interactions by the users not in the specific audience with the selected content items of the cluster, the digital magazine server 140 trains 550 a model to identify keywords or themes with which users not in the specific audience are likely to interact. For example, the digital magazine server 140 trains 550 one or more models for different components (e.g., themes, keywords, topics) of content items and characteristics of users to whom the content items are to be presented to determine 320 the likelihood of users performing one or more specific interactions with content items including the components based on characteristics of users and components of content items. Example components of content items include keywords, topics, and themes. Example characteristics of users include user interactions with content items having the keywords, topics, or themes, demographic information of users included in user profiles maintained by the online system 140. From characteristics of a user to whom a content item is to be presented and components of the content item, the model outputs a likelihood of the user performing one or more interactions with the content item. In various embodiments, the digital magazine server 140 trains 550 the model based on prior user interactions (selections, rate of selection, shares with other users, rate of sharing with other users, commenting, rate of commenting, indications of preference, rate of indications of preference) with content items provided to the users by the digital magazine server 140 and keywords, topics, or themes of the content items previously provided to the users. For example, the digital magazine server 140 applies one or more labels indicating specific types of user interactions with a content item previously provided to a user to characteristics of the user and components of the content item previously provided to the user. From the labeled characteristics of the user and components of a content of the content item previously provided to the user, the digital magazine server 140 trains 550 the model using any suitable training method or combination of training methods. After training, the digital magazine server 140 applies the trained model characteristics of users and components of content items to output a likelihood of a user performing one or more specific types of interactions with a content item based on components of the content item (e.g., topics, keywords, themes). In various embodiments, the digital magazine server 140 applies the trained model to different components of content items to identify components of content items resulting in at least a threshold likelihood of users having specific characteristics (e.g., topics, keywords, themes) performing one or more specific types of interactions. This allows the digital magazine server 140 to identify keywords or themes that increase a likelihood of users having specific characteristics performing one or more specific interactions with content items having the keywords or themes. In various embodiments, as the digital magazine server 140 further calibrates the model when content items with different components (e.g., keywords, topics, themes) are provided to users and the users perform specific interactions with the content items. This allows the digital magazine server 140 to more accurately identify components (e.g., keywords, topics, themes) of content items that increase a likelihood of users having different characteristics interacting with the content item. In various embodiments, the digital magazine server 140 trains and maintains models corresponding to different characteristics of users, allowing the digital magazine server to use the models to identify topics, keywords, themes, or other components of content items that increase likelihoods of users with different characteristics interacting with content items.

In some embodiments, the digital magazine server 140 identifies components—topics, keywords, themes—of content items resulting in at least a threshold likelihood of users having specific characteristics to one or more publishing users from the one or more trained models. This allows a publishing user to more readily identify components (e.g., topics, keywords, themes) with which users having specific characteristics are likely to interact, allowing the publishing user to more readily generate content items provided to the digital magazine server 140 with which users having the specific characteristics interacting with the content items are likely to interact. This allows a publishing user to identify components for content items that increase a likelihood of users outside an audience who already interacts with content provided by the publishing user via the digital magazine server 140, allowing the publishing user to better provide content for presentation to user having different characteristics than users who interact with content from the publishing user presented by the digital magazine server 140.

In some embodiments, a publishing user provides one or more objectives to the digital magazine server 140, which selects components (e.g., topics, keywords, themes) with which users having specific characteristics are likely to interact having at least a threshold measure of relevance or measure of similarity to the provided objectives. Further, the digital magazine server 140 may identify topics, keywords, or themes with which users have performed a threshold amount of interaction or that have a threshold likelihood of user interaction from the one or more trained models to a publishing user, providing the publishing user with information for generating content items having the identified topics, keywords, or themes to increase likelihood of user interactions with the content items from the publishing user. Additionally, from stored interactions with content items by users and components of content items presented to the users by the digital magazine server 140, the digital magazine server 140 determines changes in user interactions with content items by comparing stored interactions with content items having different topics, themes, or keywords at different times by retrieving interactions with content items having common topics, keywords, or themes stored by the digital magazine server 140 at different times. The digital magazine server 140 may modify one or more of the trained models over time as the digital magazine sever 140 receives interactions with content items from different users.

In some embodiments, from stored interactions with content items and received interactions with content items, the digital magazine server 140 identifies changes in user interaction with content items having common topics, keywords, or themes over time. The digital magazine server 140 may identify changes in user interaction with content items for users having one or more common characteristics (i.e., for a specific audience of users) or for users of the digital magazine server 140 as a whole. For example, the digital magazine server 140 identifies changes in a number of interactions with content items having particular topics, keywords, or themes at different times by users having one or more common characteristics or by overall users of the digital magazine server 140. In some embodiments, the digital magazine server 140 generates a visual representation of themes, topics, or keywords by displaying positions of themes (topics or keywords) and their relationship to each other in two dimensions. Positions of themes (topics or keywords) are fixed based on interactions with content items over time, with positions of themes (topics or keywords) relative to each other are varied based interactions with content items associated with the themes (topics or keywords) within a threshold amount of time from a current time.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining content items at a digital magazine server, each content item of the set included in at least one digital magazine maintained by the digital magazine server and each content item of the set having various characteristics;
extracting words from text included in the content item and syntax information about words in the text included in the content item;
clustering the content items based on the extracted words and syntax information so a cluster of content items includes one or more common words;
identifying one or more predominant clusters of content items;
determining one or more themes for each of the one or more predominant clusters based on words and parts of speech of the words extracted from content items of the predominant cluster, each theme including one or more words;
determining a distribution of themes associated with each of a set of the content items based on labels associated with content items and the number of times the labels were associated with content item; and
generating theme clusters based on the distribution of themes and the tone or more themes determined for each of the one or more predominant cluster, each theme cluster including content items associated with a theme corresponding to a theme cluster.

2. The method of claim 1, wherein clustering the content items based on the extracted words and syntax information so the cluster of content items includes one or more common words comprises:
retrieving a taxonomy stored by the digital magazine server, the taxonomy defining relationships between words and related words; and
clustering the content items so the cluster of content items includes one or more common words or one or more other words identified by the taxonomy as having a common meaning as at least one of the one or more common words.

3. The method of claim 2, wherein clustering the content items based on the extracted words and syntax information so the cluster of content items includes one or more common words comprise further comprises:
selecting one or more keywords for each cluster, a keyword of a cluster com comprising a word being included in at least a threshold percentage of content items of the cluster, accounting for inclusion of synonyms for or related words from the taxonomy in content items of the cluster;

4. The method of claim 1, wherein identifying one or more predominant clusters of content items comprises:
identifying predominant clusters as clusters in which content items of the cluster have at least a threshold measure of similarity to each other.

5. The method of claim 1, wherein identifying one or more predominant clusters of content items comprises:
identifying predominant clusters as clusters in which content items of the cluster have at least a threshold position in a ranking of clusters based on measures of similarity of content items within the cluster to other content items within the cluster.

6. The method of claim 1, wherein identifying one or more predominant clusters of content items comprises:
ranking the clusters based on a number of content items included in each cluster, where cluster including more content items having higher positions in the ranking;
identifying predominant clusters as clusters having at least a threshold position in the ranking.

7. The method of claim 1, further comprising:
retrieving interactions with content items by users of the digital magazine server stored by the digital magazine server;
identifying content items with which users having one or more common characteristics interacted; and
determining one or more differences between themes of content items with which users of having the one or more common characteristics interacted and themes of content items with which other users interacted.

8. The method of claim 7, wherein determining one or more differences between themes of content items with which users of having the one or more common characteristics interacted and themes of content items with which other users interacted comprises:
determining a Kullback-Leibler divergence between a distribution of themes of content items with which users having the one or more common characteristics interacted and an alternative distribution of themes of content items with which the other users interacted.

9. The method of claim 7, wherein the other users comprise users having one or more alternative characteristics in common.

10. The method of claim 7, further comprising:
training one or more models to determine likelihoods of a user performing one or more interactions with a content item based on characteristics of the user and one or more themes associated with the content item based on themes of content items with which users previously interacted and characteristics of users who interacted with the content items.

11. A computer program product comprising a non-transitory computer readable storage medium having instructions encoded thereon that, when executed by a processor, cause the processor to:
obtain content items at a digital magazine server, each content item of the set included in at least one digital magazine maintained by the digital magazine server and each content item of the set having various characteristics;
extract words from text included in the content item and syntax information about words in the text included in the content item;
cluster the content items based on the extracted words and syntax information so a cluster of content items includes one or more common words;
identify one or more predominant clusters of content items;
determine one or more themes for each of the one or more predominant clusters based on words and parts of speech of the words extracted from content items of the predominant cluster, each theme including one or more words;
determine a distribution of themes associated with each of a set of the content items based on labels associated with content items and the number of times the labels were associated with content item; and
generate theme clusters based on the distribution of themes and the tone or more themes determined for each of the one or more predominant cluster, each theme cluster including content items associated with a theme corresponding to a theme cluster.

12. The computer program product of claim 1, wherein cluster the content items based on the extracted words and syntax information so the cluster of content items includes one or more common words comprises:
retrieve a taxonomy stored by the digital magazine server, the taxonomy defining relationships between words and related words; and
cluster the content items so the cluster of content items includes one or more common words or one or more other words identified by the taxonomy as having a common meaning as at least one of the one or more common words.

13. The computer program product of claim 12, wherein cluster the content items based on the extracted words and syntax information so the cluster of content items includes one or more common words comprise further comprises:
select one or more keywords for each cluster, a keyword of a cluster com comprising a word being included in at least a threshold percentage of content items of the cluster, accounting for inclusion of synonyms for or related words from the taxonomy in content items of the cluster;

14. The computer program product of claim 11, wherein identify one or more predominant clusters of content items comprises:
identify predominant clusters as clusters in which content items of the cluster have at least a threshold measure of similarity to each other.

15. The computer program product of claim 11, wherein identify one or more predominant clusters of content items comprises:
identifying predominant clusters as clusters in which content items of the cluster have at least a threshold position in a ranking of clusters based on measures of similarity of content items within the cluster to other content items within the cluster.

16. The computer program product of claim 11, wherein identifying one or more predominant clusters of content items comprises:
rank the clusters based on a number of content items included in each cluster, where cluster including more content items having higher positions in the ranking;
identifying predominant clusters as clusters having at least a threshold position in the ranking.

17. The computer program product of claim 11, wherein the non-transitory computer readable storage medium further has instructions encoded thereon that, when executed by the processor, cause the processor to:
retrieve interactions with content items by users of the digital magazine server stored by the digital magazine server;
identify content items with which users having one or more common characteristics interacted; and
determine one or more differences between themes of content items with which users of having the one or more common characteristics interacted and themes of content items with which other users interacted.

18. The computer program product of claim 17, wherein determine one or more differences between themes of content items with which users of having the one or more common characteristics interacted and themes of content items with which other users interacted comprises:
determine a Kullback-Leibler divergence between a distribution of themes of content items with which users having the one or more common characteristics interacted and an alternative distribution of themes of content items with which the other users interacted.

19. The computer program product of claim 17, wherein the other users comprise users having one or more alternative characteristics in common.

20. The computer program product of claim 17, wherein the non-transitory computer readable storage medium further has instructions encoded thereon that, when executed by the processor, cause the processor to:
train one or more models to determine likelihoods of a user performing one or more interactions with a content item based on characteristics of the user and one or more themes associated with the content item based on themes of content items with which users previously interacted and characteristics of users who interacted with the content items.
